(19) United States
(12) Patent Application Publication
(10) Pub. No.: US 2018/0186189 A1
(43) Pub. Date: Jul. 5, 2018

(54) PNEUMATIC TIRE HAVING A CROWN THAT COMPRISES A REINFORCEMENT PLY AND A HIGH-TRACTION TREAD

(71) Applicant: COMPAGNIE GENERALE DES ETABLISSEMENTS MICHELIN, CLERMONT-FERRAND (FR)

(72) Inventors: PATRICK PALLOT, Clermont-Ferrand (FR); BENJAMIN LEVRARD, Clermont-Ferrand (FR); RÉMI REYNAL DE ST-MICHEL, Clermont-Ferrand (FR)

(21) Appl. No.: 15/580,369

(22) PCT Filed: Jun. 10, 2016
(86) PCT No.: PCT/EP2016/063374

§ 371 Date: Dec. 7, 2017

(30) Foreign Application Priority Data
Jun. 16, 2015 (FR) 1555491
Oct. 20, 2015 (FR) 1559996

(51) Int. Cl. B60C 9/20; B60C 11/00; B60C 9/30; B60C 9/18

(52) U.S. Cl. CPC B60C 9/20; B60C 11/0066; B60C 11/0008; B60C 9/30; B60C 2009/2041; B60C 11/0075; B60C 2011/0025; B60C 2009/2016; B60C 2009/2022; B60C 9/1821

(57) ABSTRACT

A tire includes two beads, two sidewalls connected to the beads, and a crown. The crown includes a belt reinforcement, a tread, and a stiffening ply. The belt reinforcement has an axial width W. The tread includes tread pattern blocks and grooves having a groove bottom. The tread is made of a material that has a dynamic shear modulus G* of less than 1.25 MPa. The stiffening ply includes filamentary reinforcing elements that are rigid in terms of compression, and that are arranged under at least one of the grooves of the tread.

### FIELD OF THE INVENTION

The present invention relates to tires, and more particularly to a tire, the grip performance of which is improved.

In general, a tire is an object exhibiting symmetry of revolution about an axis of rotation. A tire comprises two beads intended to be mounted on a rim; it also comprises two sidewalls connected to the beads, a crown comprising a tread intended to come into to contact with the ground, the crown having a first side connected to the radially exterior end of one of the two sidewalls and having a second side connected to the radially exterior end of the other of the two sidewalls.

The makeup of the tire is usually described by a representation of its constituent components in a meridian plane, which means to say a plane containing the axis of rotation of the tire. The radial, axial and circumferential directions denote the directions perpendicular to the axis of rotation of the tire, parallel to the axis of rotation of the tire and perpendicular to any meridian plane, respectively. In what follows, the expressions “radially”, “axially” and “circumferentially” respectively mean “in a radial direction”, “in the axial direction” and “in a circumferential direction” of the tire. The expressions “radially on the inside or, respectively, radially on the outside” mean “closer to or, respectively, further away from, the axis of rotation of the tire, in a radial direction, than”. The equatorial plane is a plane perpendicular to the axis of rotation of the tire, positioned axially in such a way as to intersect the surface of the tread substantially mid-way between the beads. The expressions “axially on the inside or, respectively, axially on the outside” mean “closer to or, respectively, further away from, the median plane of the tire, in the axial direction, than”.

### PRIOR ART

As is known per se, the tread of a tire for application to road vehicles, whether intended to be fitted to a passenger vehicle or to a heavy goods vehicle, is provided with a tread pattern comprising tread pattern blocks delimited by various grooves, some oriented circumferentially and others oriented axially, or still others oriented obliquely. The tread pattern blocks may also comprise various finer sipes or incisions. The grooves form channels that are intended to remove water during running on wet ground and the walls of these grooves define what are referred to as the leading and trailing edges of the tread pattern elements, on the surface of the tread, and with reference to the direction of running.

In order to improve the grip of a tire, and more particularly the grip on dry ground and on wet ground for non-winter running, it is well known practice to use, for the tread, a rubber compound of low stiffness (which means to say also of low hardness, which is where the usual designation of soft compound comes from). This reduction in tread stiffness allows the latter to better conform to the surface of the ground it is running on and in particular to conform well to the roughness of the ground, and thus the actual area of contact with the ground it is running on is increased and the grip performance improved with respect to a tread of which the rubber compound is stiffer.

Such a choice performs very well for tires the tread pattern of which has few or no grooves oriented rather circumferentially, notably on the axially exterior side of the tire. An example is given in document FR 3 007 693 A1. However, in order to encourage good removal of water and make it possible to keep the tread surface of the tire in close contact with the ground during use on very wet ground, it is necessary for the tread pattern to have enough grooves oriented rather circumferentially. In this latter configuration, the use of a less stiff rubber tread compound promotes shearing of the tread pattern blocks and rocking thereof, and this generates greatly raised pressures on the leading edges of the tread pattern blocks, and these in turn generate very significant heating. These raised pressures and this heating can contribute towards very rapid damage to the tread of the tire and to non-optimal exploitation of the grip potential of the tread compound, particularly the grip potential in an axial direction (also referred to as transverse grip).

In order to improve the transverse grip performance of tires the tread of which comprises a plurality of circumferential grooves delimited by opposing lateral faces and a groove bottom, document WO 2011/073022 A1 proposes arranging, under the carcass ply and even under the inner liner, a reinforcing ply comprising elements of the cord type, oriented substantially axially.

However, the reinforcing effect of such a structure remains limited and such a structure may prove to exhibit insufficient endurance. Document DE 10 2010 038199 A1, or its equivalent WO2012/048930 A1, gives an example of a protective reinforcing ply situated radially on the outside of two plies made up of monofilament reinforcers, forming with the carcass ply the typical triangulation of radial-carcass tires, in which example the reinforcers of the reinforcing ply make an angle of between 50° and 90° with the circumferential direction of the tire. Document EP 0 987 129 A2 gives an example of a protective reinforcing ply, situated this time again radially on the outside of two plies which, with the carcass ply, form the typical triangulation of radial-carcass tires, the purpose of which is to improve the resistance to puncturing; once again, the reinforcing ply comprises elements of the cord type, oriented at an angle close to the transverse direction. However, these teachings relate to what is known as the “plunger test” which is an objective that has nothing in common with the context of the present invention.

The objective of the present invention is to propose a better alternative for producing a tire capable of far better performance in terms of transverse grip.

### BRIEF DESCRIPTION OF THE INVENTION

The invention relates to a tire comprising a belt reinforcement arranged in the crown, usually radially on the outside of a carcass reinforcement. In the radial direction, the belt reinforcement is a stack of at least two plies coupled with a carcass ply; the said at least two plies are usually made up of metal cords, the said metal cords typically forming an angle with the circumferential direction of between +10° and +40° for one of these plies and of between −10° and −40° for the other of these plies.

A subject of the invention is a tire comprising:
two beads;
two sidewalls connected to the beads;
a crown connected on each side to the radially exterior end of each of the sidewalls, the crown comprising:
   a belt reinforcement of axial width W,
   a tread made of an elastomeric material, the tread comprising a plurality of tread pattern blocks, two axially adjacent tread pattern blocks being separated by a groove extending at least partially circumferentially, each groove being delimited radially towards the inside by a groove bottom,
      characterized in that the elastomeric material of which the tread is made has a dynamic shear modulus G*, at 60° C. and under a 10 Hz alternating stress loading of 0.7 MPa, of less than 1.25 MPa, and in that the crown comprises a stiffening ply made up of filamentary reinforcing elements that are rigid in terms of compression, the said filamentary reinforcing elements forming, with the circumferential direction, an angle of between 50° and 90°, the said stiffening ply being arranged radially on the outside of the belt reinforcement and axially under at least one groove of the tread, and extending axially at least over a width WR representing at minimum 50% of the axial width W of the belt reinforcement.

What is meant by “rigid in terms of compression” is elements of which the Young's modulus in compression in the direction of slenderness of the filamentary elements is greater than 1 GPa, and preferably 10 GPa. By way of example, the filamentary reinforcing elements are made of metal cords. Many steel cords give the stiffening ply a suitable stiffness. The filamentary reinforcing elements may also be monofilaments. They may also be formed by compressively rigid assembly of organic fibres, or alternatively of inorganic fibres such as glass fibres, carbon fibres, fibres of the aramid type, embedded in a sufficiently rigid matrix. The cross section of the monofilaments may be circular or flattened, for example of elliptical or rectangular cross section.

In order to offer the compression reinforcement performance afforded by the invention, advantageously it is appropriate for the filamentary reinforcing elements to be spaced apart in the stiffening ply by a spacing at most equal to three times the longest dimension of their cross section. The stiffening ply thus, because of its great compressive stiffness, opposes the flexing of the crown outside of its plane and thus opposes the rocking of the tread pattern elements and thus makes it possible to maintain a large area of contact with the ground on which it is running; it makes it possible to limit the raised pressures on the leading edge of the tread pattern blocks and thus limit the heating.

Thus, the stiffening ply makes it possible to use, for the tread, compounds that are considerably softer than are used in tires for passenger vehicles, and to do so without significantly prejudicing their longevity in terms of distance covered. Advantageously, the elastomeric material of which the tread is made has a dynamic shear modulus G*, at 60° C. and under a 10 Hz alternating stress loading of 0.7 MPa, of less than 1.25 MPa, namely is a material which, prior to the present invention, was confined to competition applications only.

### BRIEF DESCRIPTION OF THE FIGURES

The subjects of the invention will now be described with the aid of the appended drawing, in which:

FIG. 1 very schematically shows (without being drawn to any particular scale) a radial cross section through a tire according to one embodiment of the invention;

FIG. 2 schematically shows a radial view, with cutaway, of the tire depicted in FIG. 1;

FIGS. 3 to 8 are partial radial sections through the crown of tires illustrating alternative forms of embodiment of the invention.

### DETAILED DESCRIPTION OF THE INVENTION

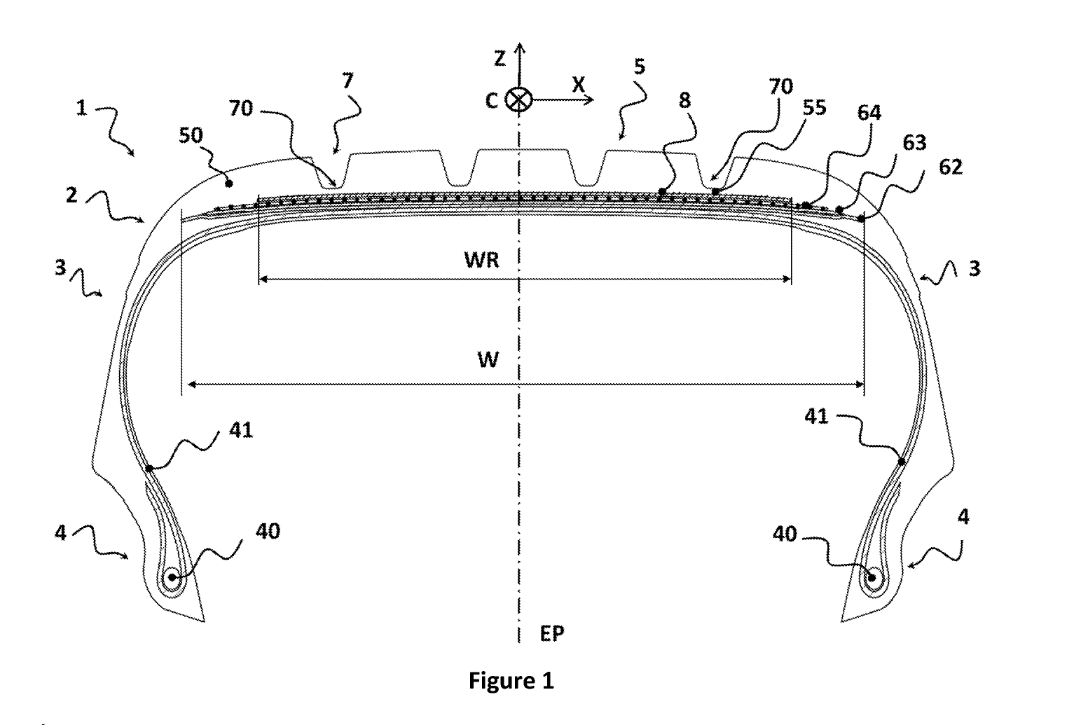

FIG. 1 shows a tire 1 comprising a crown 2, two sidewalls 3 each connected to a bead 4. The crown 2 is connected on each side to the radially exterior end of each of the two sidewalls. The crown 2 comprises a tread 5. FIG. 1 indicates an equatorial plane EP, which plane is perpendicular to the axis of rotation of the tire, situated mid-way between the two beads 4 and passes through the middle of the belt reinforcement; FIG. 1 also indicates, by arrows placed just above the tread 2, on the equatorial plane EP, the axial X, circumferential C and radial Z directions.

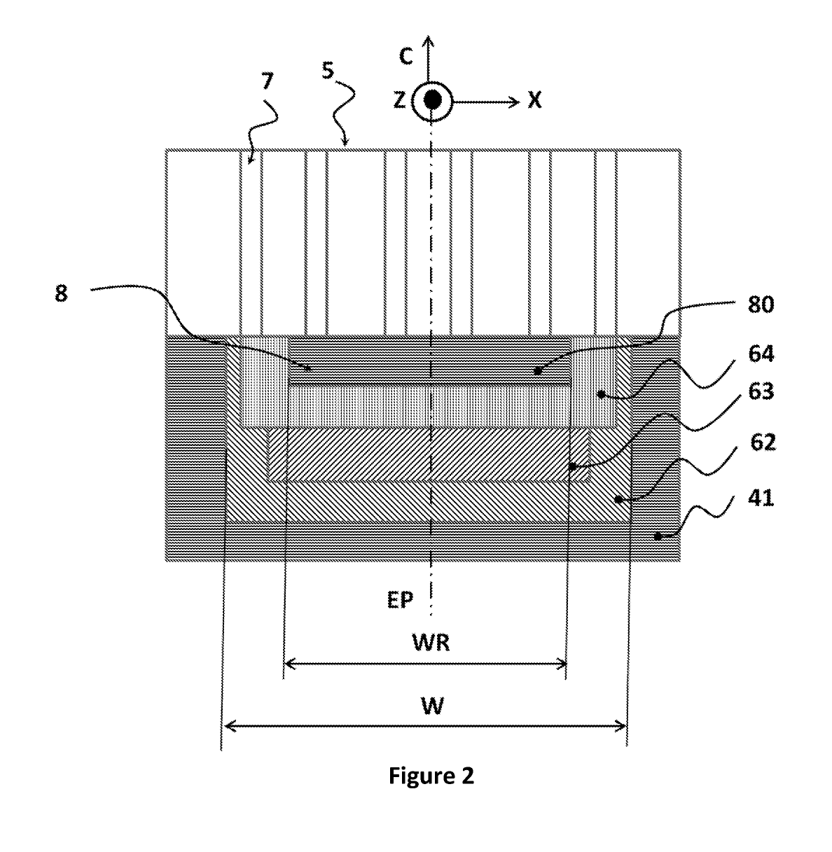

Each bead comprises a bead wire 40; a carcass ply 41 (also visible in FIG. 2) is wound around each bead wire 40. The carcass ply 41 is radial and in the way known per se is made up of cords (in this implementation, textile cords) arranged substantially parallel to one another and extending from one bead to the other in such a way that they form an angle of between 80° and 90° with the equatorial plane EP.

The crown 2 comprises (see FIGS. 1 and 2) a belt reinforcement comprising the said carcass ply 41 and two belt plies 62, 63. In a very conventional way, the belt plies 62, 63 are formed of metal cords arranged parallel to one another. In a way that is well known, the reinforcing elements that the cords of the carcass ply 41 and the cords of the belt plies 62, 63 form are oriented in at least three different directions so as to form a triangulation. The belt reinforcement has an axial width W, this width being measured from one axial end to the other of the widest (62) of the belt plies, which means to say the widest of the plies that form a triangulation with the carcass ply or plies.

The tread 5 comprises a plurality of tread pattern blocks 50. Two axially adjacent tread pattern blocks 50 are separated by a groove 7 extending at least partially circumferentially; each groove 7 is delimited radially towards the inside by a groove bottom 70.

The belt reinforcement of the tire 1 comprises a hooping ply 64 made up of hoop reinforcers formed of organic or aromatic polyamide fibres or of aramid fibres or are formed of hybrid cords containing aramid fibres, the said hoop reinforcers forming, with the circumferential direction, an angle at most equal to 5°. The hooping ply 64 comprises a single layer of hoop reinforcers. As an alternative form of embodiment, the hooping ply is made up of several layers of hoop reinforcers.

According to the invention, the tire 1 comprises a stiffening ply 8 that can be seen in FIGS. 1 and 2; this ply is formed, according to one particular embodiment of the invention, of steel cords. The steel cords are 4.26 cords arranged at an angle of 90° with a spacing of 1.25 mm. The hooping ply 64 is arranged radially on the outside of the belt plies 62, 63 and is arranged radially on the inside of the stiffening ply 8. The stiffening ply 8 is therefore, in this alternative form, arranged radially just on the outside of the hooping ply 64. The stiffening ply 8 is arranged radially and axially under the (or, depending on the embodiment, under at least one) groove 7 of the tread 5 and therefore under the groove 7 bottom 70.

The filamentary reinforcing elements of the said stiffening ply 8 (in this instance the cords) are oriented essentially radially: experimentation carried out by the applicant shows that the stiffening effect according to the invention is substantially obtained with an angle of between 50° and 90°, and preferably an angle greater than 85°. The stiffening ply as proposed by the invention indeed has two main functions:
creating a bending beam of the “composite sandwich beam” type by working with the carcass ply; the ply therefore needs to have a similar angle to the carcass ply in order to increase the meridian bending stiffness of the crown;
increasing the bending stiffness on the edge of the crown reinforcement by increasing the shear stiffness of the ply in its plane; this is at a maximum for a ply angle of 45°.

The range of angles given hereinabove thus makes it possible to limit bending in the plane and outside of the plane of the crown of the tire under transverse loading by, on the one hand, increasing the meridian bending stiffness of the crown (outside the plane), thereby limiting the rocking of the tread pattern blocks as a result of bending, and, on the other hand, increasing the bending stiffness on the edge of the crown (in the radial plane).

It has been seen that the material of which the tread 5 is made is an elastomeric material with a dynamic shear modulus G*, at 60° C. and under a 10 Hz alternating stress loading of 0.7 MPa, of less than 1.25 MPa. What is meant by “material of which the tread is made” is the material which comprises at least 50% of the volume comprised between the surface for contact with the ground when new and a level corresponding to 1.6 mm towards the outside from the groove 7 bottom 70 (1.6 mm being the usual height of the tread wear indicators).

In order not to increase the volume of the tire, the stiffening ply according to the invention can advantageously be used as a substitute for the materials generally present at the base of the tread. A layer of an elastomeric material measuring of the order of 2 mm is generally found under the groove bottom and affords the belt reinforcement protection against the attack experienced by the tire during use. The stiffening ply of the present invention may afford sufficient protection against this attack, making it possible to reduce the thickness of the said layer of elastomeric material mentioned hereinabove, for example to reduce it to 1.5 mm at most rather than 2 mm, or even to go down to a thickness of at least 0.5 mm. This reduction in thickness also makes it possible to increase the shear stiffness of the tread and thus contribute to improving the transverse roadholding of the vehicle.

It should be noted that the stiffening ply is generally a semi-finished product containing not only steel cords but also rubber referred to as skim. This is generally the case with all the plies, whether these are the carcass ply or plies, the belt plies, the hooping ply: they are made up of filamentary, monofilamentary or corded reinforcing elements coated in skim rubber which binds them together to form a semi-finished manufactured product; the rubber skim has a composition generally chosen both to meet the requirements of the manufacturing process and to give appropriate properties to the tire as a finished product. Let us recall in passing that there are manufacturing processes in which the belt ply cords are laid down thread by thread on a green tire as it is being built, without passing via the step of manufacturing a semi-finished product such as a skimmed ply; the invention is compatible with such a process. All of these considerations are nothing more than a reminder of technical data that are well known to those skilled in the art and do not in themselves form part of the invention.

The stiffening ply 8 extends axially over a width WR. By way of example, the width WR measures 140 mm for a tire of size 225/45 R 17, namely represents 70% of the width W of the crown reinforcement. Advantageously, the stiffening ply 8 is close to the mechanical neutral axis of the structural assembly formed by the crown 2 of the tire. In another embodiment, at least 70% of the said width WR of the stiffening ply is arranged on one side of the median plane EP, namely on the side intended to be mounted towards the outboard side of the vehicle, which is to say the side that is most heavily loaded in bends taken at speed. In certain implementations of the invention, the tire is therefore asymmetric. However, this is not in any way imperative, it being highly possible for the tire according to the invention to be axially symmetrical. For preference, the stiffening ply extends over a width WR representing at minimum 50% of the axial width W of the belt reinforcement and preferably at least 70%. Advantageously, the stiffening ply extends over a width WR representing at most 100% of the axial width W of the belt reinforcement.

The invention finds a quite particularly advantageous application when the grooves 7, or some of them, extend circumferentially. They may very well be grooves which are not oriented exactly circumferentially but which may be oblique with respect to the equatorial plane EP; because the means of the invention make it possible effectively to combat the tendency of tread pattern blocks to rock and the tendency of the crown to flex when the tread is made of soft rubber in order to encourage grip, and the flexing of the crown and the rocking of the tread pattern is particularly prejudicial when the tire is loaded in the transverse direction, the invention finds a quite particularly beneficial application when there are grooves that are at least partially oriented circumferentially. Of course, there may also be grooves oriented mainly axially, and in that case the invention makes it possible to combat the rocking of the tread pattern blocks 50 in the event of longitudinal loading, originating from a high torque, for example under emergency braking. The stiffening ply 8 forms part of the belt reinforcement of the tire 1; the stiffening ply 8 is directly connected with the belt plies 62, 63 and with the hooping ply 64. That makes it possible to stiffen the crown 2 and effectively limits, or even prevents, the rocking of the tread pattern blocks 50 of the tread 5.

The addition of the stiffening ply 8 contributes to strong mechanical coupling with the belt plies 62 and 63, forming a non-deformable triangle, particularly at the centre of the tire, when the coupling is well established. Thus, when the tire is spun, the centre of the tire in the vicinity of the equatorial plane EP does not deform, whereas the shoulders experience deformation (or radial extension) under the effect of the inertial forces. This difference in radial extension under the effect of spinning therefore causes a certain weakness of the tire at high speeds and may cause premature damage to the tire. As a result, in one quite particularly advantageous implementation, the invention comprises a hoop particularly suited to preventing any significant radial extension according to the maximum speed level set for the tire.

One way, in concrete terms, of adjusting the design of a tire according to a given performance specification is for the hooping ply to extend axially beyond the edge of the widest (62) of the belt plies by at least 3 mm and preferably at least 5 mm, so as to improve the relative extension stiffness of the tire at the shoulders. This aspect will be revisited in the description of the fifth alternative form of embodiment hereinbelow. Another way is to use, for the materials of which the hooping ply is made, materials that are far stiffer in terms of extension, such as aramid or hybrid cords like aramid. Yet another way is for this hooping ply to be made up of several layers of reinforcers at the shoulder, more numerous than in the centre of the tire, where coupling with the stiffening ply 8 is already performing this role. Finally, further mention is made of another way which consists in the hooping ply at the shoulders being preloaded, either because it has been laid on a tire building drum at a smaller radius at the shoulders than at the centre, before the tire is shaped in the vulcanizing press, or because it has been laid on a tire building drum under tension with greater tension at the shoulders than at the centre.

### Tests

The invention was tested by creating tires of the size 225/45 R 17. The reference tire is a MICHELIN Pilot Sport 3 tire. The test tires are all derived from the MICHELIN Pilot Sport 3 tire in respect of elements not specific to the present invention, and for which no indication is given hereinbelow.

| VARIANTS | TIMING |
|---|---|
| Tire with tread G* 60° C. 10 Hz 1.4 MPa without | 2 min 18.7 s |
| stiffening ply | |
| Tire with tread G* 60° C. 10 Hz 1.4 MPa with | 2 min 18.7 s |
| stiffening ply | |
| Tire with tread G* 60° C. 10 Hz 1.1 MPa without | 2 min 18.3 s |
| stiffening ply | |
| Tire with tread G* 60° C. 10 Hz 1.1 MPa with | 2 min 17.6 s |
| stiffening ply | |
| Tire with tread G* 60° C. 10 Hz 0.9 MPa without | 2 min 16.9 s |
| stiffening ply | |
| Tire with tread G* 60° C. 10 Hz 0.9 MPa with | 2 min 15.7 s |
| stiffening ply | |
| Tire with tread G* 60° C. 10 Hz 0.4 MPa without | 2 min 15.7 s |
| stiffening ply | |
| Tire with tread G* 60° C. 10 Hz 0.4 MPa with | 2 min 13.5 s |
| stiffening ply | |

The table above in each instance gives the timing with and without the stiffening ply. The reference tire achieves a timing of 2 minutes 18.7 seconds. The difference is considered significant in this test when a 0.3 second improvement is made.

In order to create an elastomeric material of which the tread 5 is made that has a dynamic shear modulus G* of 0.9 MPa, reference may be made for example to the formulation below:

TABLE 1
formulation

| Composition | Example (phr) |
|---|---|
| SBR (a) | 100 |
| Silica (b) | 110 |
| Coupling agent (c) | 9 |
| Liquid plasticizer (d) | 20 |
| Resin plasticizer (e) | 50 |
| Black | 5 |
| Zinc oxide | 3 |
| Stearic acid | 2 |
| Antioxidant (f) | 2 |
| Accelerator (g) | 2 |
| DPG | 2 |
| Sulfur | 1 |

with:
(a) SBR with 27% styrene, 1,2-butadiene: 5%, cis-1,4: 15%, trans-1,4: 80% Tg = −48° C.
(b) “Zeosi11165MP” silica from Solvay with BET surface area of 160 m²/g
(c) “S169” TESPT silane from Evonik
(d) “Flexon 630” TDAE oil from Shell
(e) “Escorez 2173” resin from Exxon
(f) Antioxidant “Santoflex 6PPD” from Solutia
(g) Accelerator “Santocure CBS” from Solutia

TABLE 2
Mechanical properties of the compositions after vulcanization

| Composition | Example |
|---|---|
| G* modulus at 60° C. (MPa) | 0.9 |
| Tg (° C.) Tanδ max | −10 |

Dry time trials were held on the Charade circuit near Clermont-Ferrand, using a Renault® Clio® Cup vehicle (front (AV) pressure 2.3 b rear (ARR) pressure 2.7 b). Several tires were manufactured using materials of different stiffnesses for the tread: the dynamic shear modulus G*, at 60° C. and under 10 Hz alternating stress loading of 0.7 MPa is at the levels of 1.4 MPa, 1.1 MPa, 0.9 MPa, and 0.4 MPa. A person skilled in the art will know how to adapt the formulation in order to vary the dynamic shear modulus G* in the range indicated hereinbelow, notably the levels at 0.9 MPa, for example, by increasing the proportion of plasticizer. To summarize the aspect of the invention relating to the dynamic shear modulus G*, at 60° C. and under 10 Hz alternating stress loading of 0.7 MPa of the material of which the tread is made, this is preferably less than or equal to 1.1 MPa and advantageously less than or equal to 0.9 MPa.

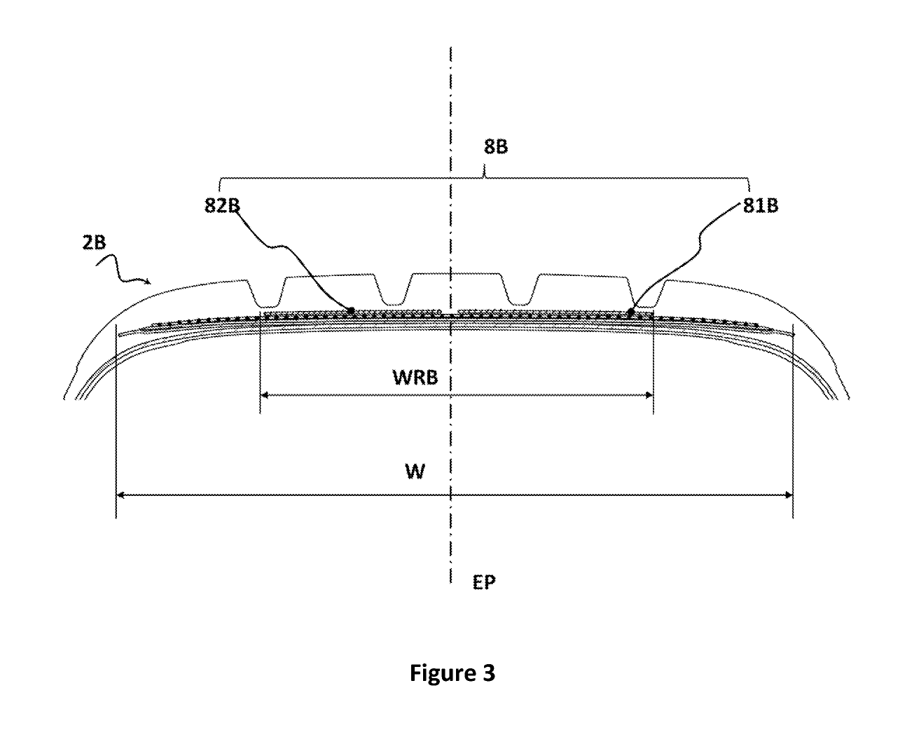

FIG. 3 shows a radial section through a crown 2B of a tire according to a first alternative form of embodiment in which the stiffening ply 8B is made and configured axially as several sections of plies separated axially by a zone that does not contain any filamentary reinforcing elements: several sections of stiffening plies can be seen (in this particular instance, two sections of stiffening plies) 81B and 82B. The stiffening ply 8B is of total width WRB (the sum of the widths of the two sections of stiffening plies 81B and 82B) representing at least 50% of the axial width W of the belt reinforcement. In all other respects this alternative form is identical to the first example, which means that there is no need to describe the other elements of the tire.

This solution makes it possible to limit the coupling of the stiffening ply with the belt plies at the centre of the tire, making it possible to limit the stiffening at the centre of the tire, something which results in better casing integrity at limiting speed and a reduced impact on external noise. This alternative form allows a 15 km/h improvement on the limiting speed of the casing and a 0.7 dB reduction in external noise referred to as “coast-by” noise according to the relevant standard, for timings identical to the alternative form comprising just one continuous ply.

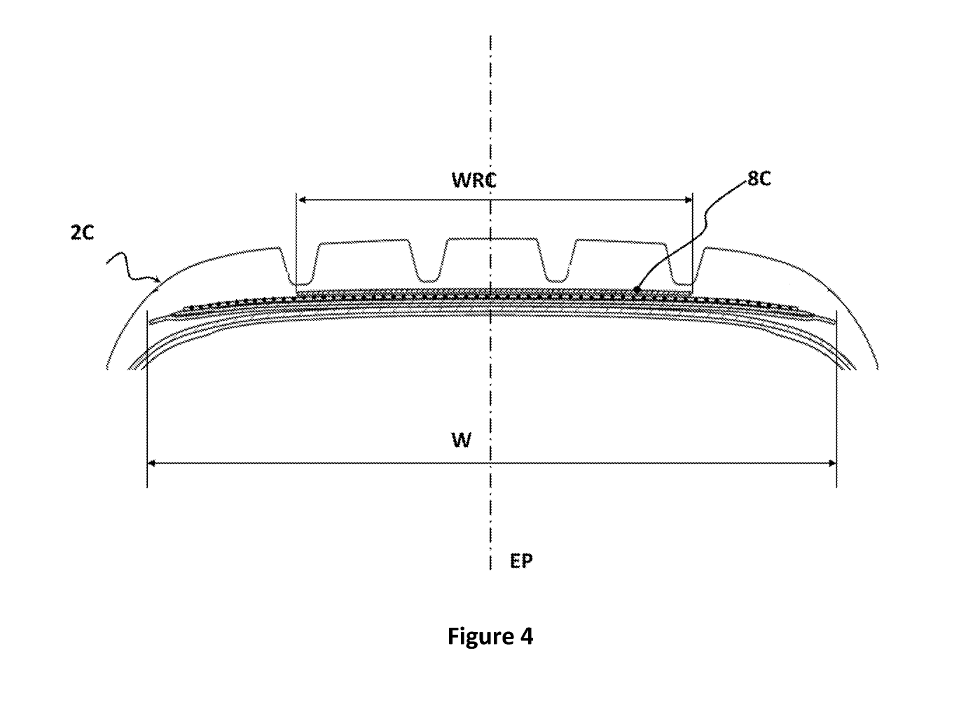

FIG. 4 shows a radial section through a crown 2C of a tire according to a second alternative form of embodiment in which the stiffening ply 8C is 30 mm narrower (width of 110 mm rather than 140 mm), this being a width representing 50% of the crown reinforcement rather than 70% in the previous versions. This makes it possible to reduce the mass of the tire while at the same time guaranteeing a very good level of performance. In all other respects this alternative form is identical to the first example, which means that there is no need to describe the other elements of the tire.

This alternative form allows a weight saving in the tire and also allows an improvement in rolling resistance through the positioning of the stiffening ply at the place where the radius of curvature of the crown of the tire is the greatest, thus preventing the meridian flexing from being constrained by the stiffening ply.

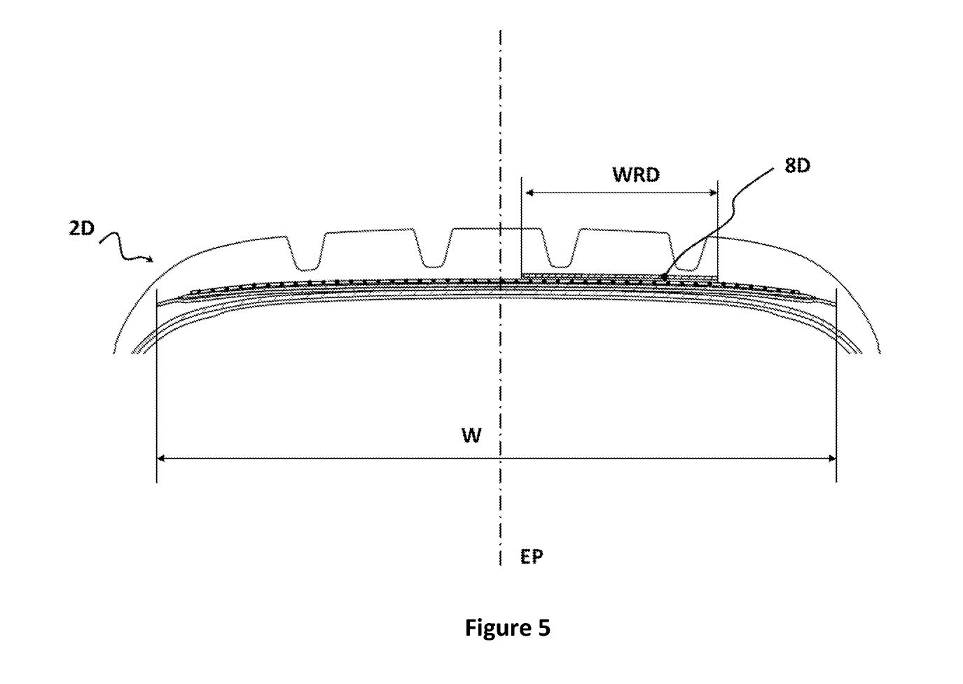

FIG. 5 shows a radial section through a crown 2D of a tire according to a third alternative form of embodiment in which the stiffening ply 8D is of smaller width and positioned asymmetrically. It is more particularly under those tread pattern blocks that are intended to be positioned toward the outboard side of the vehicle that it is quite particularly advantageous to stiffen the crown. This makes it possible to reduce the mass of the tire while at the same time guaranteeing a very good level of performance. In all other respects this alternative form is identical to the first example, which means that there is no need to describe the other elements of the tire.

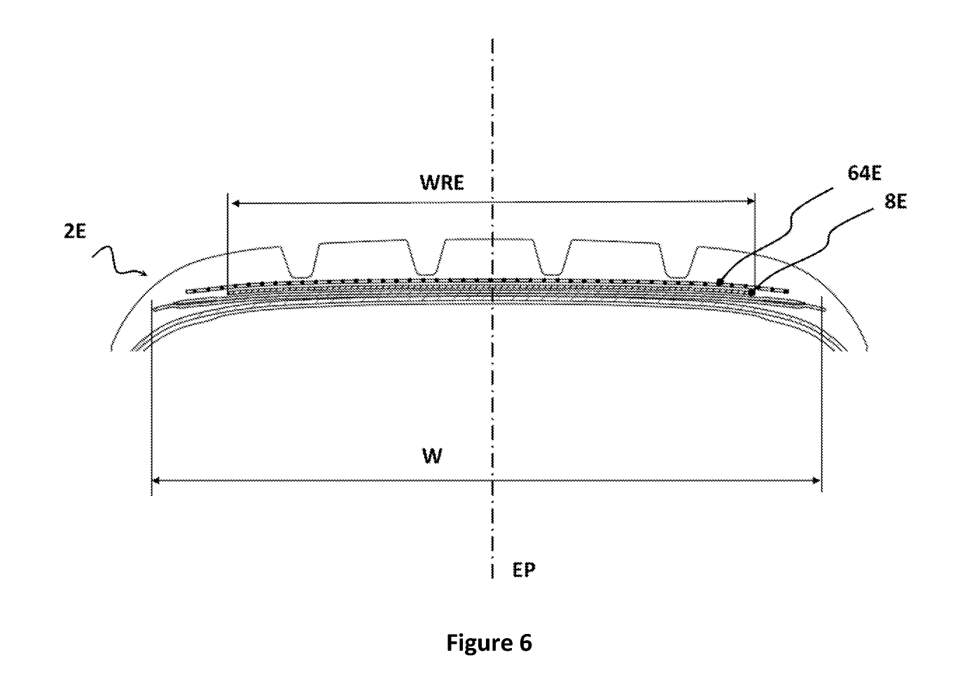

FIG. 6 shows a radial section through a crown 2E of a tire according to a fourth alternative form of embodiment in which the hooping ply 64E is arranged radially on the outside of the stiffening ply 8E. In all other respects this alternative form is identical to the first example, which means that there is no need to describe the other elements of the tire. This alternative form allows better functional coupling of the stiffening ply with the crown of the tire because its positioning is closer to the neutral axis of the crown (which is considered to behave like a beam), thereby improving the bending stiffness of the crown in its plane (with a benefit in terms of the cornering thrust of the tire), without opposing the flattening of the crown when the crown enters the contact patch, which flattening is essential to the tire having good grip on the ground.

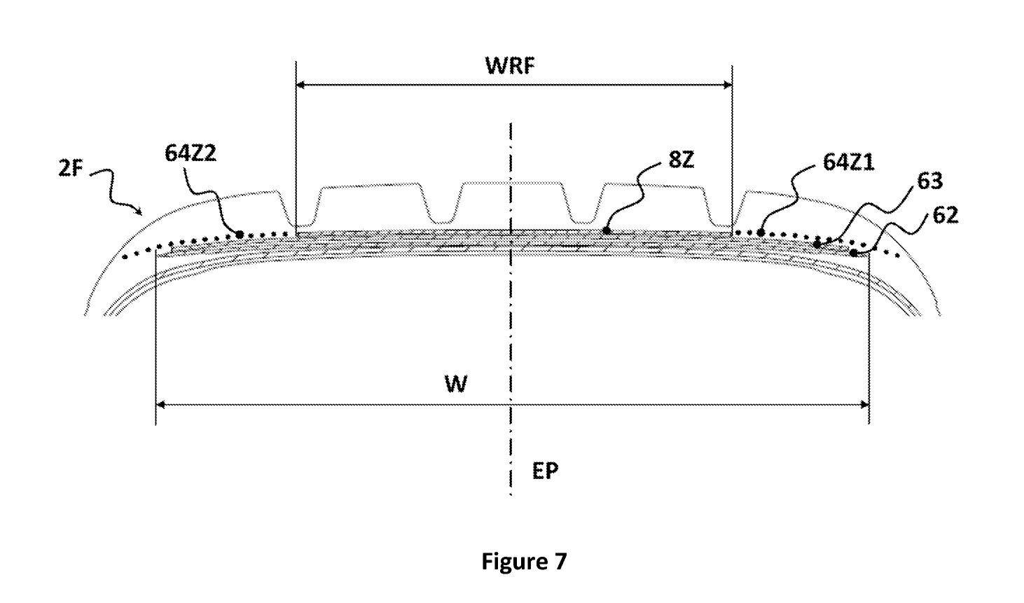

FIG. 7 shows a radial section through a crown 2F of a tire according to a fifth alternative form of embodiment in which the hooping ply is formed by at least two axially separated hooping zones 64Z1, 64Z2 positioned on either side of the stiffening ply 8Z. Give or take the curvature of the crown, the hooping ply and the stiffening ply are thus positioned at the same radial distance. In the same figure and according to another aspect that can be used independently of the hoop being produced as two hooping zones, it may be seen that the hooping ply (hooping zone 64Z1 together with the hooping zone 64Z2) extends axially beyond each of the axial ends of the widest (62) of the belt plies over a distance of at least 3 mm. For preference, this distance measures from 5 mm to 10 mm. This last aspect may be implemented with a continuous hooping ply as illustrated in the other embodiments.

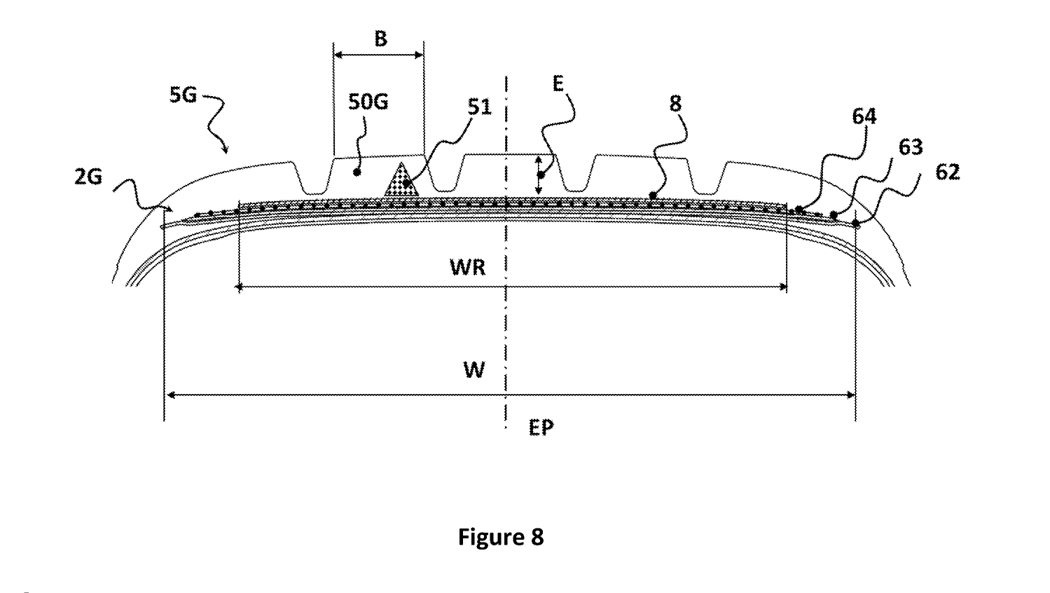

FIG. 8 shows a radial section through a crown 2G of a tire according to a sixth alternative form of embodiment in which at least one tread pattern block 50G comprises an anchoring element 51 extending radially from the radially exterior surface of the said stiffening layer 8 towards the outside of the tread 5G as far as a radial height greater than 75% of the radial thickness E of the tread. The said anchoring element is of variable axial width, varying from a maximum value of less than 50% and preferably less than 25% of the axial width B of the said block 51G, the said axial width decreasing with radially upwards progression. The angle of the two lateral walls of the said anchoring element is preferably comprised between 35 and 45 degrees, namely for example 40°, as illustrated in FIG. 8. The said anchoring element is made of a rubber compound with a stiffness greater than the stiffness of the rubber compound of the rest of the tread. What is meant by the “stiffness” of the compound is its dynamic shear modulus G*, at 60° C. and under 10 Hz alternating stress loading of 0.7 MPa. For example, advantageously, the said material of which the anchoring element is made preferably has a dynamic modulus G*, measured at 60° C. at 10 Hz and under an alternating shear stress of 0.7 MPa, of greater than 20 MPa and very preferably greater than 30 MPa.

1-16. (canceled)

17. A tire comprising:
two beads;
two sidewalls connected to the beads; and
a crown connected on each side thereof to a radially exterior end of a respective one of the two sidewalls, the crown including:
a belt reinforcement having an axial width W,
a tread that includes a plurality of tread pattern blocks, wherein:
for at least one pair of axially adjacent tread pattern blocks a groove extending at least partially circumferentially separates the at least one pair of tread pattern blocks,
each groove is delimited radially in an interior direction by a groove bottom, and
the tread is made of a material that has a dynamic shear modulus G*, at 60° C. and under 10 Hz alternating stress loading of 0.7 MPa, of less than 1.25 MPa, and
a stiffening ply that includes filamentary reinforcing elements that are rigid in terms of compression, wherein:
the filamentary reinforcing elements form, with a circumferential direction C, an angle in a range of between 50° and 90°,
the filamentary reinforcing elements are arranged radially outside of the belt reinforcement and axially under at least one groove of the tread, and
the filamentary reinforcing elements extend axially at least over a width WR of the stiffening ply, the width WR being at a minimum 50% of the axial width W of the belt reinforcement.

18. The tire according to claim 17, wherein the material of which the tread is made has a dynamic shear modulus G*, at 60° C. and under 10 Hz alternating stress loading of 0.7 MPa, of less than 1.1 MPa.

19. The tire according to claim 17, wherein the material of which the tread is made has a dynamic shear modulus G*, at 60° C. and under 10 Hz alternating stress loading of 0.7 MPa, of less than 0.9 MPa.

20. The tire according to claim 17, wherein the filamentary elements of the stiffening ply have a Young's modulus in compression, in a direction of slenderness of the filamentary elements of the stiffening ply, that is greater than 1 GPa.

21. The tire according to claim 17, wherein the stiffening ply is arranged such that an interposition of a layer of an elastomeric material measuring at least 0.5 mm and at most 1.5 mm is between the stiffening ply and each groove bottom.

22. The tire according to claim 17, wherein at least 70% of the width WR of the stiffening ply is arranged on one side of a median plane perpendicular to an axis of rotation of the tire.

23. The tire according to claim 17, wherein the width WR of the stiffening ply extends over a minimum of 70% of the axial width W of the belt reinforcement.

24. The tire according to claim 17, wherein the width WR of the stiffening ply extends over at most 100% of the axial width W of the belt reinforcement.

25. The tire according to claim 17, wherein the stiffening ply is configured axially as a plurality of sections separated axially by a zone that does not contain any filamentary reinforcing elements.

26. The tire according to claim 17, wherein the filamentary reinforcing elements form, with the circumferential direction, an angle greater than 85°.

27. The tire according to claim 17, further comprising a hooping ply that includes hoop reinforcers, wherein the hoop reinforcers form, with the circumferential direction, an angle at most equal to 5°.

28. The tire according to claim 27, wherein the hooping ply is arranged radially external to the stiffening ply.

29. The tire according to claim 27, wherein the hooping ply is arranged radially internal to the stiffening ply.

30. The tire according to claim 27, wherein the hooping ply is formed of at least two axially separated hooping zones positioned on opposite sides of the stiffening ply.

31. The tire according to claim 30, wherein:
the crown includes a plurality of belt plies having axial ends, and
each of the hooping zones protrudes axially beyond a respective one of the axial ends of a widest of the belt plies by a distance of at least 3 mm.

32. The tire according to claim 17, wherein:
the crown includes a plurality of belt plies having axial ends, and
axial ends of the hooping ply protrude axially beyond corresponding axial ends of a widest of the belt plies by a distance of at least 3 mm.

33. The tire according to claim 17, wherein:
at least one tread pattern block includes an anchoring element that extends radially from a radially exterior surface of the stiffening ply outwards towards an external portion of the tread as far as a radial height greater than 75% of a radial thickness of the tread, and
the anchoring element has an axial width that varies from a maximum value of less than 25% of an axial width of the at least one tread pattern block, the axial width decreasing in a radially outward direction towards the external portion of the tread, and
the anchoring element is made of a rubber compound having a stiffness greater than a stiffness of a rubber compound forming a remainder of the tread.
